(19) United States
(12) Patent Application Publication
(10) Pub. No.: US 2026/0268519 A1
(43) Pub. Date: Sep. 10, 2026

(54) CAMERA POSE ESTIMATION USING NEURAL NETWORKS

(71) Applicant: GDM Holding LLC, Mountain View, CA (US)

(72) Inventors: Arjun Madhav Karpur, San Francisco, CA (US); Tiago Novello de Brito, Rio de Janeiro (BR); Ye Xia, Mountain View, CA (US); Songyou Peng, San Francisco, CA (US); Zhen Hao Zhou, Sunnyvale, CA (US); Andre Filgueiras de Araujo, Sao Paulo (BR)

(21) Appl. No.: 19/561,357

(22) Filed: Mar. 9, 2026

Related U.S. Application Data
(60) Provisional application No. 63/768,869, filed on Mar. 7, 2025.

(51) Int. Cl. G06T 7/73

(52) U.S. Cl. CPC G06T 7/73; G06T 2207/20081; G06T 2207/20084; G06T 2207/30244

(57) ABSTRACT

Systems and methods for performing camera pose estimation using a neural network. In particular, the camera pose of one or more images in a set of images is estimated using point maps generated by the neural network for the images in the set of images.

### CROSS-REFERENCE TO RELATED APPLICATION

This application claims the benefit under 35 U.S.C. § 119 (e) of U.S. Patent Application No. 63/768,869, filed on Mar. 7, 2025. The disclosure of the foregoing application is incorporated herein by reference in its entirety for all purposes.

### BACKGROUND

This specification relates to processing images using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that performs pose estimation on a given set of images. That is, the system generates a respective camera pose estimate for each of one or more of the images in the given set.

The camera pose estimate for a given image estimates a camera pose of a camera that captured the image. For example, the camera pose estimate can be a relative camera pose estimate that is relative to a particular one of the set of images, e.g., that estimates the change in camera pose between the given image and the particular image.

The subject matter described in this specification can be implemented in particular embodiments so as to realize one or more of the following advantages.

Camera pose estimation remains a core, unsolved problem in computer vision. With many modern applications, e.g., novel-view synthesis, few-view 3D reconstruction, and video generation, requiring high-quality pose estimates, being able to recover camera pose from two or more images is only becoming more important.

In order to recover camera poses for a collection of images with overlapping scene content, robust Structure-from-Motion (SfM) techniques can be used to build an explicit model of the surface geometry and corresponding cameras. Typically, these pipelines include separate stages for feature extraction and matching, point triangulation, camera parameter estimation, and bundle adjustment for joint refinement across multiple views. Any stage is susceptible to failure, especially in the presence of wide camera baselines and textureless regions; thus, much attention has been focused on how to bypass SfM using data-driven approaches.

Modern feed-forward techniques have shown impressive performance in sparse reconstruction settings. These methods can recover camera poses well, even in the presence of extremely low-overlap image pairs, by predicting per-pixel surface geometry points in a shared co-ordinate space (i.e., pointmaps) and using robust estimators to solve for camera parameters. However, these methods are data-hungry and require an abundance of image pairs with ground truth camera and surface geometry annotations.

This specification describes techniques that overcome these shortcomings by using a pointmap-based model that reconstructs scenes parameterized as 3D gaussians from two or more unposed images and uses novel view synthesis as a proxy task for learning accurate camera pose estimation. This results in robust camera pose estimates under any of a variety of image conditions and camera pose ranges. The described techniques also incorporate a geometric loss, e.g., a ray alignment loss, that reduces deviation of the Gaussians from the underlying Plucker rays, further improving the quality of pose estimates generated by the model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram of an example pose estimation system.

FIG. 1B shows an example of the operation of the system.

FIG. 2 is a flow diagram of an example process for generating a camera pose estimate.

FIG. 3 is a flow diagram of an example process for training the camera pose estimation neural network.

FIG. 4 shows an example of the performance of the described techniques.

Like reference numbers and designations in the various drawings indicate like elements.

### DETAILED DESCRIPTION

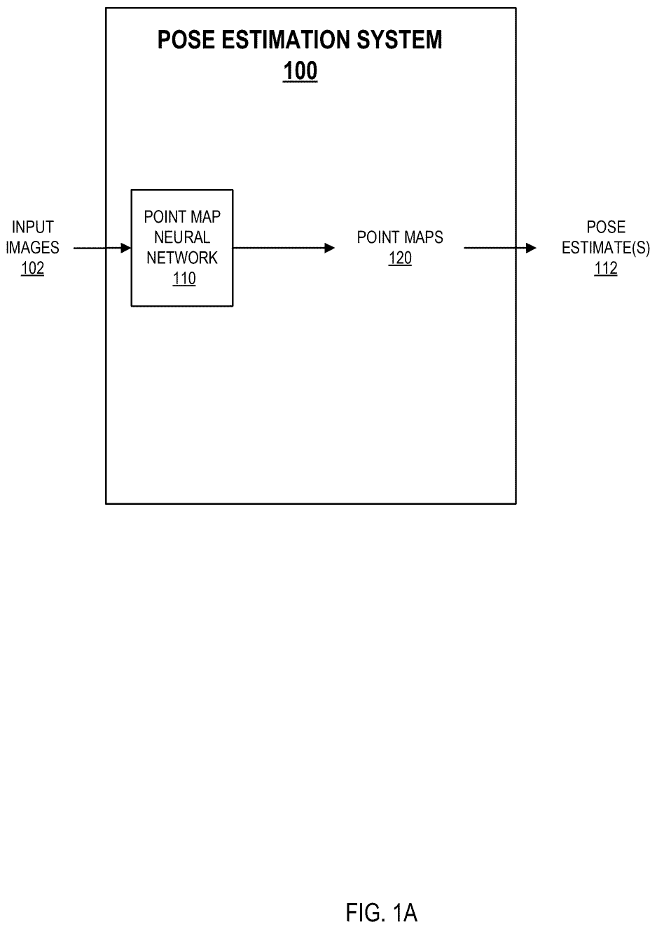

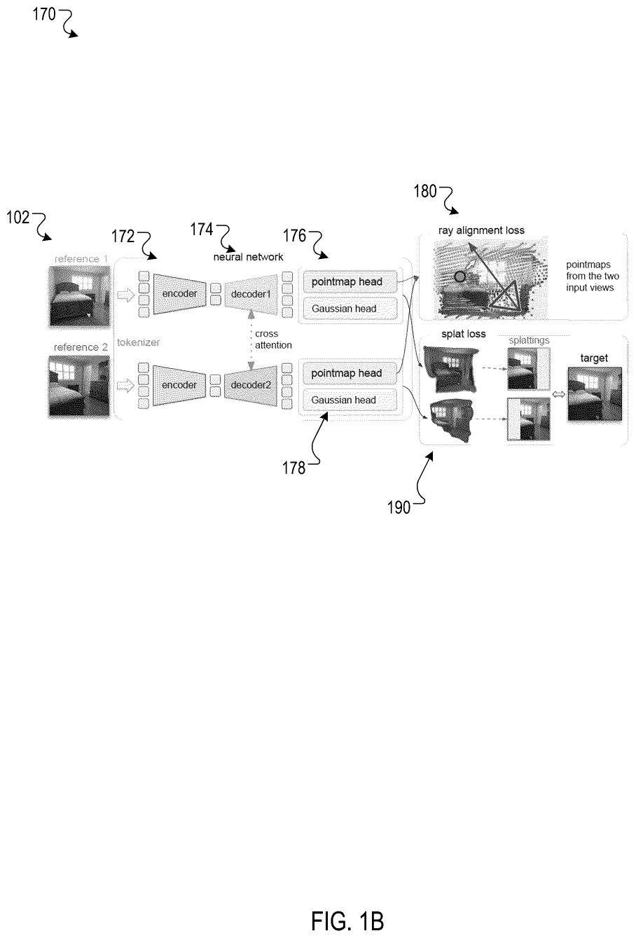

FIG. 1A shows an example pose estimation system 100. The pose estimation system 100 is an example of a system implemented as computer programs on one or more computers in one or more locations in which the systems, components, and techniques described below are implemented.

The system 100 performs pose estimation on a given set of images 102.

That is, the system 100 generates a respective camera pose estimate 112 for each of one or more of the images 102 in the given set.

The camera pose estimate 112 for a given image 102 estimates a camera pose of a camera that captured the image. For example, the camera pose estimate can be a relative camera pose estimate that is relative to a particular one of the set of images, e.g., that estimates the change in camera pose between the given image and the particular image.

In particular, the system 100 obtains a plurality of images 102 of the scene. The plurality of images 102 of the scene generally have overlapping scene content, i.e., each of the images has an overlapping field of view with at least one of the other images 102.

The system 100 processes the plurality of images of the scene using a point mapping neural network 110 to generate a respective point map 120 for each of the images. The respective point map 120 for each image includes a respective three-dimensional (3D) coordinate estimate for each pixel that estimates a 3D coordinate of the pixel.

The system 100 then processes the respective point maps 120 for each of the images to generate a respective camera pose estimate 112 for one or more of the plurality of images 102 that estimates a camera pose of a camera that captured the image 102.

For example, the system 100 can process the respective point maps 120 for each of the images using a Perspective-n-Point solver 140 to generate the respective camera pose estimate 112 for one or more of the plurality of images 102. For example, for a given one of the one or more images, the camera pose estimate can specify the rotation and the translation of the camera pose of the given image relative to a designated one of the images 102.

Once the system has generated the camera pose estimates 112, the system 100 can output the camera pose estimates or use the estimates to perform one or more computer vision tasks.

Some examples of such tasks now follow.

One example of such a task is novel-view synthesis. Novel-view synthesis requires camera pose estimates as input for rendering consistent images of a scene from new, unobserved viewpoints, as the pose defines the virtual camera's location and orientation.

Another example of such a task is few-view 3D reconstruction. Few-view 3D Reconstruction relies on pose estimates for accurately triangulating 3D points from corresponding features across multiple images and scaling the resulting scene model.

Another example of such a task is video generation. Video generation, specifically view interpolation, uses pose estimates to guide the smooth, geometrically-consistent transition between frames by defining the camera path in 3D space.

Another example of such a task is structure-from-Motion (SfM) refinement. More specifically often uses pose estimates as an initial guess or constraint for bundle adjustment to jointly refine camera poses and 3D structure.

Augmented Reality (AR) critically depends on pose estimates for correctly aligning and overlaying virtual content onto the real-world view captured by the camera.

Image Stitching and Panorama Generation require camera pose estimates to register and warp individual images onto a common projection surface, ensuring geometric alignment.

3D Scene Understanding and Semantic Mapping utilize pose estimates to project 2D image-based semantic labels or object detections into a consistent 3D map of the environment.

Prior to using the point mapping neural network 102, the system 100 trains the neural network 102 on training examples that each include a set of (posed) training images.

For example, the system 100 can train the neural network on an objective that, for each training example, includes a photometric loss that is determined based on respective Gaussian distributions for the pixels of the training images. The Gaussian distributions are defined by parameters that are generated by the point mapping neural network, optionally augmented with an auxiliary Gaussian output neural network head.

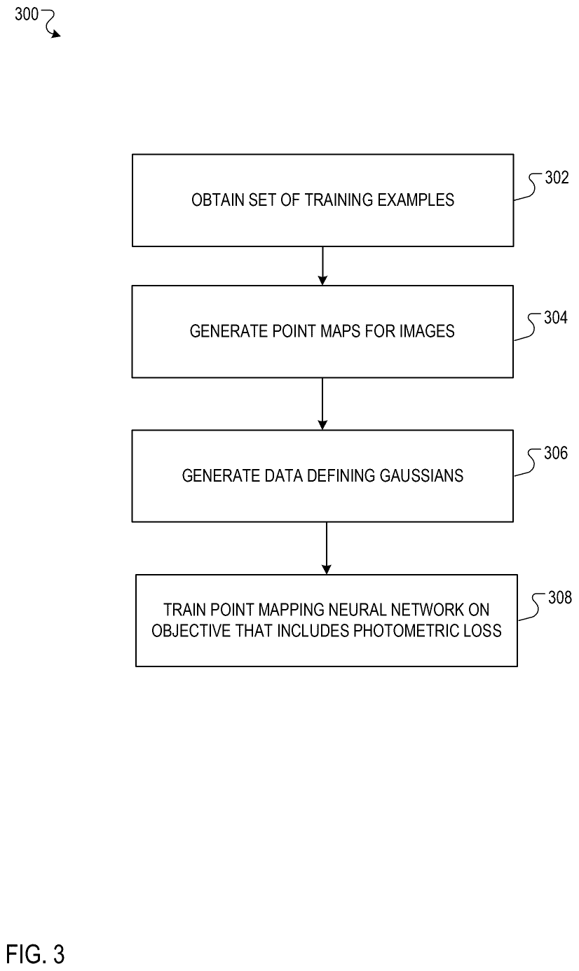

This training is described in more detail below with reference to FIGS. 1B and 3.

FIG. 1B shows an example 170 of the operation of the system 100.

As shown in FIG. 1B, the system obtains a plurality of images 102 of a scene. In the example 170, the system obtains two reference images, reference image 1 and reference image 2. As can be seen from the example 170, the reference images generally have overlapping content.

The system 100 processes the plurality of images of the scene using the point mapping neural network 110 to generate a respective point map 120 for each of the images. As described above, the respective point map 120 for each image includes a respective three-dimensional (3D) coordinate estimate for each pixel that estimates a 3D coordinate of the pixel. For example, the 3D coordinate estimates can be estimates in a canonical coordinate system that is shared between the plurality of images. For example, the canonical coordinate system can be the local camera coordinate system of the designated one of the images of the plurality of images or a different coordinate system that is centered at a specified location within the scene.

As shown in the example 170, the neural network 110 has an encoder-decoder architecture.

That is, the point mapping neural network 110 includes an encoder neural network 172, a decoder neural network 174, and a point mapping neural network head 176.

To generate the point maps 112, the system 100 processes each of the plurality of images 102 using the encoder neural network 172 to generate a respective encoded representation for each image that includes a respective encoder output for each of a plurality of patches of the image. For example, the encoder output for a given patch can be a vector of numerical values, e.g., floating point or other numerical values.

The encoder neural network 172 can generally have any appropriate architecture that maps an image to an encoded representation of the image. For example, the encoder neural network 172 can have vision Transformer architecture or another architecture that includes a sequence of self-attention layers. As another example, the encoder neural network 172 can have a convolutional neural network architecture. As yet another example, the encoder neural network 172 can have a hybrid architecture that includes both convolutional and self-attention layers.

The system 100 then processes the encoded representations of the plurality of images using the decoder neural network 174 to generate a respective decoded representation for each image that includes a respective decoder output for each of the plurality patches of the image. For example, the decoder output for a given patch can be a vector of numerical values, e.g., floating point or other numerical values.

For example, the decoder neural network 174 can have an architecture that includes a sequence of layers. Then, the decoded representation can be the encoder outputs after being updated by the last layer in the sequence.

In some examples, the sequence of layers includes one or more self-attention layers.

Each self-attention layer is configured to, for each patch of each image, update the respective encoder output for the patches of the image by applying self-attention over the encoder outputs for each of the patches of each of the images.

In some other examples, the sequence of layers includes one or more self-attention layers and one or more cross-attention layers.

Each self-attention layer is configured to, for each image, update the respective encoder outputs for each of the patches of the image by applying self-attention over the encoder outputs for each of the patches of the image.

Each cross-attention layer is configured to, for each image, update the respective encoder outputs for each of the patches of the image by applying cross-attention into the respective encoder outputs for the patches of one or more of the other images in the plurality of images.

For each image and for each patch of the image, the system 100 can then process the decoder output for the patch using the point mapping neural network head 176 to generate the respective three-dimensional (3D) coordinate estimates for the pixels in the patch.

The point mapping neural network head 176 can generally have any appropriate neural network architecture. For example, the point mapping neural network head 176 can be a multi-layer perceptron (MLP) or a self-attention neural network.

The system 100 can then process the respective point maps for each of the images to generate a respective camera pose estimate for one or more of the plurality of images. For example, in the example 170, the system 100 can process the respective point maps for the images to generate a camera pose estimate for reference image 2 that is relative to the pose of reference image 1, i.e., that specifies a difference between the absolute pose of reference image 2 and the absolute pose of reference image 1.

For example, to generate the camera pose estimate(s), the system can process the respective point maps for each of the images using a Perspective-n-Point solver to generate the respective camera pose estimate for one or more of the plurality of images.

A Perspective-n-Point solver is a computer vision algorithm used to estimate the pose (position and orientation) of a camera given its intrinsic parameters and a set of n 3D points in the world and their corresponding 2D projections in the image. In this system, the 3D points are provided by the respective point maps for each of the images, and the PnP solver uses these correspondences to calculate the relative camera pose between the images.

For example, the system can use the solver described in Richard Hartley and Andrew Zisserman. Multiple View Geometry in Computer Vision. Cambridge university press, 2003, optionally with RANSAC optimization as described in Martin A Fischler and Robert C Bolles. Random sample consensus: a paradigm for model fitting with applications to image analysis and automated cartography. Communications of the ACM, 1981. Any other appropriate PnP solver can be used.

As described above, prior to using the neural network 110 to estimate camera poses, the system 100 or another training system trains the neural network 110 on training data. The training data includes a set of training examples that each include a respective plurality of training images.

In particular, during training, after processing the plurality of training images of the scene using the point mapping neural network to generate a respective point map for each of the training images, the system 100 generates, for each training image, data defining a respective Gaussian distribution for each pixel of the training image using at least the 3D coordinate estimate for the pixel.

The system then trains the point mapping neural network 110 on an objective that includes a photometric loss that is determined based on the respective Gaussian distributions for the pixels of the training images.

For example, as shown in the example 170, during training, the point mapping neural network 110 can also include a Gaussian neural network head 178.

The Gaussian neural network head 178 can, for each image and for each patch of the image, process the decoder output for the patch to generate respective additional parameters for the respective Gaussian distributions for the pixels in the patch.

That is, the data defining a respective Gaussian distribution for each pixel of the training image includes a mean of the respective Gaussian distribution that is based on, e.g., is equal to or otherwise proportional to, the 3D coordinate estimate for the pixel and the respective additional parameters for the respective Gaussian distribution for the pixel generated by the Gaussian neural network head 178.

For example, the additional parameters can include one or more of opacity, quaternion, scale, color, spherical harmonics, and so on.

Thus, the system can train, on the objective, the Gaussian neural network head 178 jointly with the point mapping neural network 110, i.e., jointly with the point mapping neural network head 176, the decoder neural network 174, and the encoder neural network 172.

More specifically, to compute the photometric loss, the system 100 can generate a respective reconstruction of a target image for each of the training images, where the respective reconstruction of the target image for a given one of the training images is generated from the respective Gaussian distributions for the pixels of the training image, and not from the respective Gaussians for any of the other training images. Thus, this loss can measure, for each training image, an error between the target image and the reconstruction of the target image generated for the training image.

In the example 170, the system 100 generates a respective reconstruction of the target image for a given training image by using the respective Gaussian distributions for the pixels of the given training image by applying Gaussian splatting to the respective Gaussian distributions for the pixels of the training image. The loss is therefore referred to as a “splat” loss 190.

That is, instead of generating a single reconstruction of the target image from the respective Gaussians for all of the training images, the system generates a separate reconstruction of the target for each of the training images.

This alleviates issues raised by the fact that, if a corresponding pair of co-visible Gaussians accurately represented their local surface well, their combined splatting could lead to an over-representation of that surface, possibly leading to deviations from the ground truth image. To overcome this, the model must learn to attenuate the opacities of the two co-visible Gaussians. However, lower opacities reduce the loss function gradient propagation to the other Gaussian parameters, likely leading to a less accurate geometry representation and consequently, worse camera pose estimation.

To address this issue of co-visible Gaussians, the system rasterizes the Gaussians from each training image separately and supervises each of the rendered images independently. Thus, since the co-visible Gaussians from two training images are never splatted together, both of them are optimized to best represent the geometry of the local surface.

To provide additional supervision for the point maps, e.g., to regularize the point maps, the objective can also include a geometric loss that is evaluated using the respective point maps for each of the images. For example, as shown in the example 170, the geometric loss can be a ray alignment loss 180 that aligns the respective point maps with corresponding Plucker rays. As a particular example, the ray alignment loss can minimize Gaussian ray misalignment by supervising the respective predicted point maps to lie along the ground-truth Plucker rays.

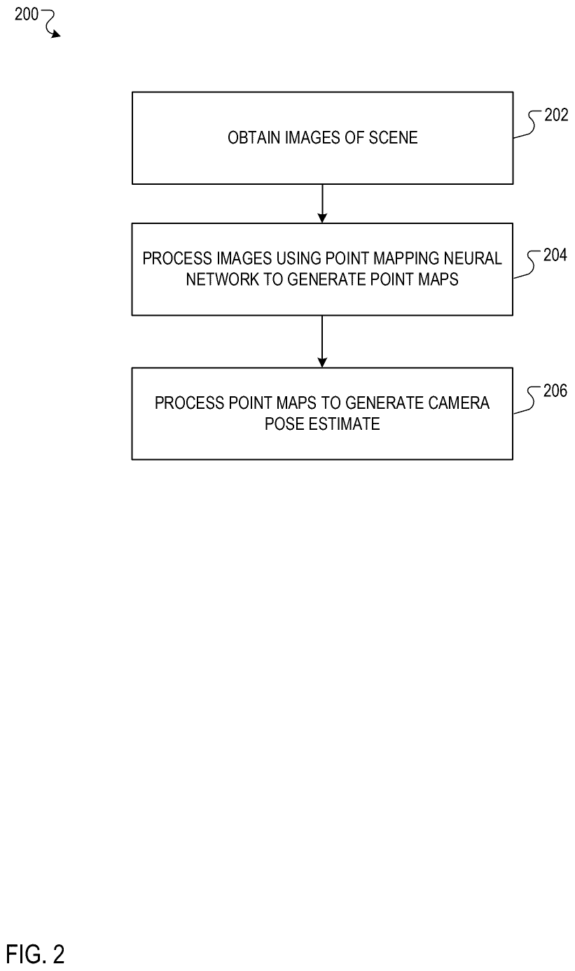

These losses will be described in more detail below with reference to FIG. 2.

FIG. 2 is a flow diagram of an example process 200 for generating camera pose estimates. For convenience, the process 200 will be described as being performed by a system of one or more computers located in one or more locations. For example, a pose estimation system, e.g., the pose estimation system 100 of FIG. 1A, appropriately programmed in accordance with this specification, can perform the process 200.

The system obtains a plurality of images of a scene (step 202).

The system processes the plurality of images of the scene using a point mapping neural network to generate a respective point map for each of the images (step 204). The respective point map for each image includes a respective three-dimensional (3D) coordinate estimate for each pixel that estimates a 3D coordinate of the pixel. For example, the 3D coordinate estimates can be estimates in a canonical coordinate system that is shared between the plurality of images.

The system processes the respective point maps for each of the images to generate a respective camera pose estimate for one or more of the plurality of images that estimates a camera pose of a camera that captured the image (step 206). For example, the respective camera pose estimate can be a relative estimate that is relative to a camera pose of a particular one of the plurality of images. As a particular example, the system can process the respective point maps for each of the images using a Perspective-n-Point solver to generate the respective camera pose estimate for one or more of the plurality of images.

More specifically, the system can generate the camera pose estimates using the solver without applying any photometric refinement to the respective point maps. This can greatly reduce the latency of generating the camera pose estimates while still maintaining high accuracy due to the architecture and training of the point mapping neural network. That is, while some other techniques need to refine an initial set of pose estimates to arrive at a high quality set of estimates, the system can generate high quality pose estimates without needing to apply any refinement.

FIG. 3 is a flow diagram of an example process 300 for training the point mapping neural network. For convenience, the process 300 will be described as being performed by a system of one or more computers located in one or more locations. For example, a pose estimation system, e.g., the pose estimation system 100 of FIG. 1A, appropriately programmed in accordance with this specification, can perform the process 300.

The system can repeatedly perform iterations of the process 300 to train the point mapping neural network.

The system obtains a set of training examples that each include a respective plurality of training images (step 302).

The system then performs steps 304 and 306 for each training example in the set.

The system processes the plurality of training images in the training example using the point mapping neural network to generate a respective point map for each of the training images (step 304).

For each training image, the system generates data defining a respective Gaussian distribution for each pixel of the training image using at least the 3D coordinate estimate for the pixel (step 306).

In particular, for each image and for each patch of the image, the system processes the decoder output for the patch using a Gaussian neural network head to generate respective additional parameters, e.g., one or more of opacity, quaternion, scale, or spherical harmonics, for the respective Gaussian distributions for the pixels in the patch.

Thus, the data defining a respective Gaussian distribution for each pixel of the training image includes a mean of the respective Gaussian distribution that is based on the 3D coordinate estimate for the pixel and the respective additional parameters for the respective Gaussian distribution for the pixel generated by the Gaussian neural network head.

The system trains the point mapping neural network on an objective that includes a photometric loss that, for each training example, is determined based on the respective Gaussian distributions for the pixels of the training images (step 308). More specifically, the system trains the Gaussian neural network head jointly with the point mapping neural network on the objective.

To evaluate the photometric loss, the system can generate, for each training example, a respective reconstruction of a target image for each of the plurality of images. Thus, the photometric loss measures, for each training example and each training image in the training example, an error between the target image and the respective reconstruction of the training image generated for the training image and from the respective Gaussian distributions for the pixels of the training image.

The target image can be, e.g., a designated one of the training images in the training example or an additional image of the same scene as the images in the training example captured from a target view that is different from any of the training images in the training example. For example, both the images in the training example and the target image can be video frames from a video of the scene, with the target image being selected from the video frames in the scene that are not included in the training example, e.g., from the video frames that are between the first training image and the last training image in the video.

More generally, the target image is an image of the same scene as the images in the training example captured from a target view, where the target view can be the same as or different from the views of any of the training images in the training example.

The system can generate a reconstruction of the target image using the respective Gaussian distributions for the pixels of the training images by applying Gaussian splatting to the respective Gaussian distributions for the pixels of the training image.

Gaussian splatting is a computer graphics technique used for fast, high-quality novel-view synthesis. It represents a 3D scene as a collection of 3D Gaussian distributions, each defined by a position (mean), an ellipsoid shape (covariance matrix), opacity, and a color model (e.g., spherical harmonics). Rendering a new view is achieved by projecting (“splatting”) these 3D Gaussians onto the 2D image plane and blending them in depth-sorted order. Thus, the system uses Gaussian splatting as a differentiable rendering technique to compute the photometric loss during training.

For example, the photometric loss for a given training example t that corresponds to a scene s and includes two training images I can be expressed as:

$${ℓ}_{splat} ( s ) = 0.5 ( \vert {I}^{t} - {\hat{I}}^{t} ( - {ℊ}^{1} ) \vert + \vert {I}^{t} - {\hat{I}}^{t} ( - {ℊ}^{2} ) \vert )$$

Here, I^{t} is the target image, g¹ are the Gaussian distributions for the first training image in the training example, I^{t}(g¹) is the reconstruction generated by applying Gaussian splatting to g¹, g² are the Gaussian distributions for the other training image in the training example, and I^{t}(g²) is the reconstruction generated by applying Gaussian splatting to g².

To provide additional supervision for the point maps, e.g., in order to regularize the training, the objective can also include a geometric loss. For example, for each training example, the geometric loss can align the respective point maps with corresponding Plücker rays.

A Plücker ray is a mathematical construct used in 3D geometry to represent a line in space, combining both its position and direction into a single vector-pair representation. In the context of computer vision and multi-view geometry, a Plucker ray defines the line of sight (ray) passing from a camera's center of projection through a specific pixel into the 3D scene. This provides a rigorous way to represent the 3D location where a 2D image feature must lie in the world, given the camera's pose. As a specific example, the geometric loss can minimize Gaussian ray misalignment by supervising the respective predicted point maps to lie along the ground-truth Plücker rays.

For example, the geometric loss for a given image I′ in the training example can be expressed as:

$${ℓ}_{ray} ( s ) = ‖ {\hat{d}}^{v} - 〈 {d}^{v} , {\hat{d}}^{v} 〉 {d}^{v} ‖ , where {\hat{d}}^{v} := {μ}^{v} - {o}^{v} ,$$

and μ^{v} is the point map for the given image I^{v}, μ^{v} is the camera origin for the given image I^{v}, d^{v} is the per-pixel view direction for the given image I^{v}, and s is the underlying scene depicted in the training example.

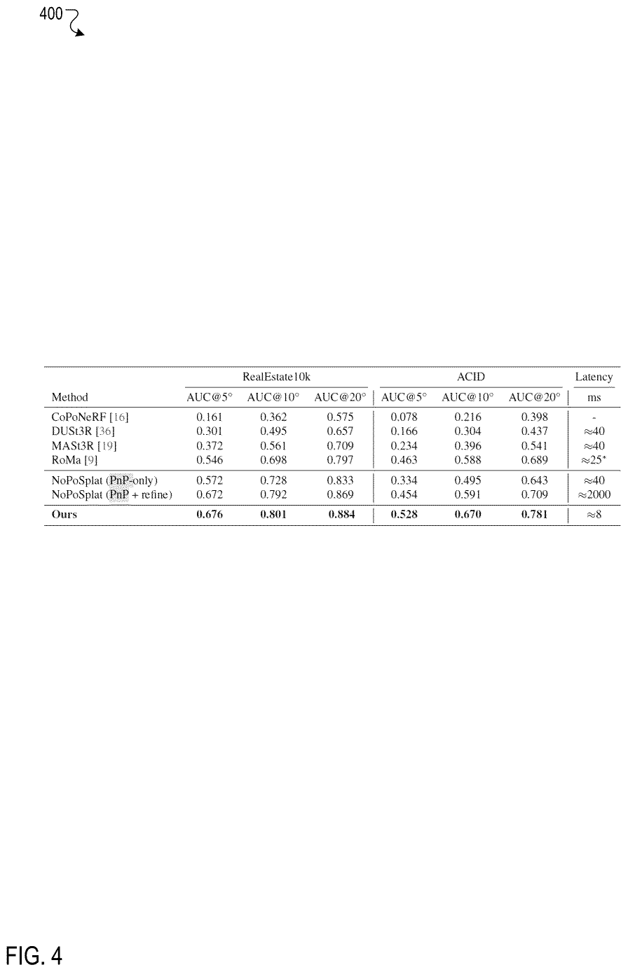

FIG. 4 shows an example 400 of the described techniques. In particular, the example 400 compares the described techniques (“ours”) to state-of-the-art techniques for relative pose estimation from two views. Notably, DUSt3R and MASt3R require ground truth cameras and depth values at training time, while CoPoNeRF, NoPoSplat, and the described techniques only require ground truth cameras for training. As can be seen from the example 400, the described techniques yield state-of-the-art performance across all rotation error thresholds for the RealEstate10k and ACID datasets. Moreover, the described techniques are entirely feed-forward, while NoPoSplat relies on an expensive photometric refinement post-processing stage, causing the described method to be 40× faster while maintaining or improving pose estimation quality.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively, or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining a plurality of images of a scene;
processing the plurality of images of the scene using a point mapping neural network to generate a respective point map for each of the images, wherein the respective point map for each image comprises a respective three-dimensional (3D) coordinate estimate for each pixel that estimates a 3D coordinate of the pixel; and
processing the respective point maps for each of the images to generate a respective camera pose estimate for one or more of the plurality of images that estimates a camera pose of a camera that captured the image.

2. The method of claim 1, wherein the 3D coordinate estimates are estimates in a canonical coordinate system that is shared between the plurality of images.

3. The method of claim 1, wherein the respective camera pose estimate is a relative estimate that is relative to a camera pose of a particular one of the plurality of images.

4. The method of claim 1, wherein processing the respective point maps for each of the images to generate a respective camera pose estimate for one or more of the plurality of images that estimates a camera pose of a camera that captured the image comprises:
processing the respective point maps for each of the images using a Perspective-n-Point solver to generate the respective camera pose estimate for one or more of the plurality of images.

5. The method of claim 4, wherein processing the respective point maps for each of the images using a Perspective-n-Point solver to generate the respective camera pose estimate for one or more of the plurality of images comprises processing the respective point maps for each of the images using the Perspective-n-Point solver without applying any photometric refinement to the respective point maps.

6. The method of claim 1, wherein the point mapping neural network comprises an encoder neural network, a decoder neural network, and a point mapping neural network head, and wherein processing the plurality of images of the scene using a point mapping neural network to generate a respective point map for each of the images comprises:
processing each of the plurality of images using the encoder neural network to generate a respective encoded representation for each image that comprises a respective encoder output for each of a plurality patches of the image;
processing the encoded representations of the plurality of images using the decoder neural network to generate a respective decoded representation for each image that comprises a respective decoder output for each of the plurality patches of the image; and
for each image and for each patch of the image, processing the decoder output for the patch using the point mapping neural network head to generate the respective three-dimensional (3D) coordinate estimates for the pixels in the patch.

7. The method of claim 6, wherein the decoder neural network comprises:
one or more self-attention layers that, for each image, update the respective encoder outputs for each of the patches of the image by applying self-attention over the encoder outputs for each of the patches of the image; and
one or more cross-attention layers that, for each image, update the respective encoder outputs for each of the patches of the image by applying cross-attention into the respective encoder outputs for the patches of one or more of the other images in the plurality of images.

8. The method of claim 1, wherein the point mapping neural network has been trained on a set of training examples that each include a respective plurality of training images.

9. The method of claim 8, wherein the training comprises, for training example in the set:
processing the plurality of training images of the scene using the point mapping neural network to generate a respective point map for each of the training images;
for each training image, generating data defining a respective Gaussian distribution for each pixel of the training image using at least the 3D coordinate estimate for the pixel; and
training the point mapping neural network on an objective that includes a photometric loss that is determined based on the respective Gaussian distributions for the pixels of the training images.

10. The method of claim 9, wherein generating data defining a respective Gaussian distribution for each pixel of the training image using at least the 3D coordinate estimate for the pixel comprises:
for each image and for each patch of the image, processing the decoder output for the patch using a Gaussian neural network head to generate respective additional parameters for the respective Gaussian distributions for the pixels in the patch.

11. The method of claim 10, wherein the data defining a respective Gaussian distribution for each pixel of the training image comprises:
a mean of the respective Gaussian distribution that is based on the 3D coordinate estimate for the pixel; and
the respective additional parameters for the respective Gaussian distribution for the pixel generated by the Gaussian neural network head.

12. The method of claim 11, wherein the respective additional parameters comprise one or more of opacity, quaternion, scale, or spherical harmonics.

13. The method of claim 10, wherein training the point mapping neural network neural network on an objective that includes a photometric loss comprises training the Gaussian neural network head jointly with the point mapping neural network.

14. The method of claim 9, wherein training the point mapping neural network neural network on an objective that includes a photometric loss that is determined based on the respective Gaussian distributions for the pixels of the training images comprises:
for each training image, generating a respective reconstruction of a target image using the respective Gaussian distributions for the pixels of the training image.

15. The method of claim 14, wherein the photometric loss measures, for each training image, an error between the target image and the respective reconstruction of the target image generated for the training image.

16. The method of claim 14, wherein generating a respective reconstruction of the training image using the respective Gaussian distribution for the pixels of the training images comprises generating the respective reconstruction by applying Gaussian splatting to the respective Gaussian distributions for the pixels of the training image.

17. The method of claim 9, wherein the objective further comprises a geometric loss.

18. The method of claim 17, wherein the geometric loss aligns the respective point maps with corresponding Plucker rays.

19. The method of claim 18, wherein the geometric loss minimizes Gaussian ray misalignment by supervising the respective predicted point maps to lie along the ground-truth Plucker rays.

20. A system comprising one or more computers and one or more storage devices storing instructions that when executed by the one or more computers cause the one more computers to perform operations comprising:
obtaining a plurality of images of a scene;
processing the plurality of images of the scene using a point mapping neural network to generate a respective point map for each of the images, wherein the respective point map for each image comprises a respective three-dimensional (3D) coordinate estimate for each pixel that estimates a 3D coordinate of the pixel; and
processing the respective point maps for each of the images to generate a respective camera pose estimate for one or more of the plurality of images that estimates a camera pose of a camera that captured the image.

21. One or more non-transitory computer storage media storing instructions that when executed by one or more computers cause the one more computers to perform operations comprising:
obtaining a plurality of images of a scene;
processing the plurality of images of the scene using a point mapping neural network to generate a respective point map for each of the images, wherein the respective point map for each image comprises a respective three-dimensional (3D) coordinate estimate for each pixel that estimates a 3D coordinate of the pixel; and
processing the respective point maps for each of the images to generate a respective camera pose estimate for one or more of the plurality of images that estimates a camera pose of a camera that captured the image.
